(19) United States
(12) Patent Application Publication
(10) Pub. No.: US 2013/0127283 A1
(43) Pub. Date: May 23, 2013

(54) ROTOR OF AN ELECTRIC MOTOR AND MANUFACTURING METHOD OF SAME

(71) Applicants: Masashi Matsumoto, Nagoya-shi (JP); Katsuhide Kitagawa, Seto-shi (JP); Makoto Yoshida, Takahama-shi (JP)

(72) Inventors: Masashi Matsumoto, Nagoya-shi (JP); Katsuhide Kitagawa, Seto-shi (JP); Makoto Yoshida, Takahama-shi (JP)

(73) Assignee: TOYOTA JIDOSHA KABUSHIKI KAISHA, Toyota-shi (JP)

(21) Appl. No.: 13/702,012

(22) PCT Filed: Jun. 4, 2011
(86) PCT No.: PCT/IB11/01209

§ 371 Date: Feb. 6, 2013

(30) Foreign Application Priority Data
Jun. 4, 2010 (JP) 2010-128627

(51) Int. Cl. H02K 1/27; H02K 15/03

(52) U.S. Cl. CPC H02K 1/2713; H02K 1/2706; H02K 15/03
USPC 310/156.11; 29/598

(57) ABSTRACT

A rotor of an electric motor is provided in which a cylindrical rotor core that is formed by stacked magnetic steel sheets and includes permanent magnets is crimp-fixed to a rotor shaft. The rotor core is directly fixed, in the axial direction of the rotor shaft, between a flange portion that is provided on an outer periphery of the rotor shaft and abuts against one axial end surface of the rotor core, and a crimping member that is crimp-fixed on the rotor shaft while pressure-contacting the other axial end surface of the rotor core.

### BACKGROUND OF THE INVENTION

1. Field of the Invention

The invention relates to a rotor of an electric motor. More particularly, the invention relates to a rotor of an electric motor, in which a rotor core formed by stacked magnetic steel sheets is fixed by crimping to a rotor shaft.

2. Description of the Related Art

An electric motor is known as a device that converts electric energy into mechanical power. Typically, an electric motor includes a generally cylindrical stator in which a coil is wound around a plurality of teeth that protrude from an inner peripheral portion, and a rotor that is rotatably provided inside the stator.

FIG. 5 is a view of one example of such a rotor. This rotor 50 includes a cylindrical rotor core 52, a rotor shaft 54 that extends completely through a center portion of the rotor core 52, end plates 56 arranged contacting both sides of the rotor core 52 in the axial direction of the rotor shaft 54 (and the rotor core 52) indicated by arrow X, and a fixing member 58 that fixes the rotor core 52 and the end plates 56 on the rotor shaft 54.

The rotor core 52 is formed by stacking multiple magnetic steel sheets, each of which has been formed by stamping a silicon steel plate or the like in an annular shape, in the axial direction and integrally joining them together. These magnetic steel sheets that make up the rotor core 52 may be joined together in the axial direction to form a plurality of separate blocks that together will make up the rotor core 52, and then these blocks may be integrally joined together in the axial direction by crimping, adhesion or welding, or the like, or all of the magnetic steel sheets that make up the rotor core 52 may be integrally joined all together by crimping, adhesion, or welding, or the like. Also, a plurality of permanent magnets 60 are embedded in an even arrangement in the circumferential direction in a portion near an outer peripheral portion of the rotor core 52.

The rotor shaft 54 is made of round-bar steel and has a flange portion 55 that protrudes radially outward formed on the outer periphery. This flange portion functions as a contact portion that abuts against one of the end plates 56, and thereby positions the rotor core 52 in the axial direction on the rotor shaft 54 during assembly of the rotor 50.

The end plates 56 are formed by circular plates that have generally the same outer shape as the axial end surfaces of the rotor core 52. Plates of aluminum that is a metal that is nonmagnetic, relatively lightweight, inexpensive, and easy to machine are often used for the end plates 56. These end plates 56 that are provided on both sides of the rotor core 52 in the axial direction have a variety of functions, e.g., they press on the rotor core 52 from both sides, they correct any imbalance in the rotor 50 by being machined (i.e., cut or shaved) in parts after the rotor 50 has been assembled, and they prevent the permanent magnets 60 from flying off of the rotor core 52 in the axial direction.

The fixing member 58 includes a cylindrical crimping portion 62 and a pressing portion 64 that protrudes radially outward from one end portion of the crimping portion 62. The fixing member 58 is fixed on the rotor shaft 54 by the crimping portion 62 being crimped to the rotor shaft 54 while the rotor core 52 and the two end plates 56 are pressed toward the flange portion 55 by the pressing portion 64. As a result, the rotor core 52 is fixed, together with the end plates 56, to the rotor shaft 54.

For example, Japanese Patent Application Publication No. 2005-168074 (JP-A-2005-168074) describes a rotor of a rotating electrical machine in which the rotor and end plates are fixed to a rotor shaft by crimping an inner peripheral end portion of the end plates to a flange portion integrally provided on the rotor shaft.

Also, Japanese Patent Application Publication No. 2007-135371 (JP-A-2007-135371) describes technology in which a rotor core and end plates that are arranged on both sides of the rotor core in the axial direction are fixed to a rotor shaft by a crimping plate.

The linear coefficient of expansion of the end plates made of aluminum sheets such as those described above is greater than that of the rotor core made of steel sheets. Therefore, if the end plates such as those described above are used in a rotor, the desired fixing power in the axial direction will not be able to be obtained for the rotor core at low temperatures unless the initial pressure contact force of the fixing member with respect to the end plates is increased anticipating the amount of shrinkage of the end plates at low temperatures. As a result, crimping equipment capable of crimp-fixing the fixing members in a state pressure contacting the rotor core with a large pressure contact force becomes large and expensive.

### SUMMARY OF THE INVENTION

The invention thus provides a rotor of an electric motor, in which at least one of the end plates has been eliminated by fixing the rotor core directly to the rotor shaft, as well as a manufacturing method of this rotor.

A first aspect of the invention relates to a rotor of an electric motor, in which a rotor core that is formed by stacked magnetic steel sheets and includes a permanent magnet is fixed to a rotor shaft. The rotor core is directly fixed, in an axial direction of the rotor shaft, to a contact portion that is provided on an outer periphery of the rotor shaft and that abuts against one axial end surface of the rotor core. The term “directly fixed” in this case refers to the rotor core being fixed to the contact portion without using a separate constituent element.

In the rotor according to the aspect described above, a permanent magnet insertion hole for inserting the permanent magnet may be formed extending in the axial direction in the rotor core, in the rotor core, and a weight-reducing hole for reducing a weight of the rotor may be formed extending in the axial direction, in a position radially inward of the permanent magnet insertion hole, in the rotor core. Also, the weight-reducing hole may be open at least at one axial end surface of the rotor core.

Also, in the rotor described above, the permanent magnet inserted into the permanent magnet insertion hole may be fixed in place by resin material filled between an inner wall of the permanent magnet insertion hole and a side surface of the permanent magnet.

In this case, an open portion, in the axial end surface of the rotor, of the permanent magnet insertion hole may be closed off by the resin material.

A second aspect of the invention relates to a manufacturing method of a rotor of an electric motor, in which a rotor core that is formed by stacked magnetic steel sheets and provided with a permanent magnet is fixed to a rotor shaft. This manufacturing method includes forming the rotor core by stacking the magnetic steel sheets; inserting the permanent magnet into a permanent magnet insertion hole in the rotor core; fixing the permanent magnet to the rotor core by filling resin material into the permanent magnet insertion hole; inserting the rotor shaft into a shaft attachment hole in a center portion of the rotor core and directly abutting one axial end surface of the rotor core against a contact portion provided on an outer periphery of the rotor shaft.

The rotor of a motor and the manufacturing method according to the first and second aspects of the invention enables at least one of the end plates to be eliminated from the rotor by directly fixing the rotor core to the contact portion of the rotor shaft. As a result, the pressure contact force between the rotor core and the contact portion can be improved.

In addition, the rotor may advantageously include a fixing member that is fixed on the rotor shaft while pressure-contacting the other axial end surface of the rotor core, so that the rotor core is directly fixed, in the axial direction of the rotor shaft, between the contact portion and the fixing member. Such a fixing member can advantageously be a crimping member that is crimp-fixed on the rotor shaft. As a result, a desired fixing force in the axial direction at low temperatures can be obtained even if the initial pressure contact force of the fixing member is relatively small, and the fixing equipment can be small and inexpensive. Also, the initial pressure contact force can be reduced as described above, so the fixing member can also be weaker and less expensive by making it thinner or changing the material or the like. Furthermore, eliminating the end plates reduces the number of component parts, thus making it possible to reduce the cost of the rotor, as well as makes the electric motor lighter which helps to reduce the energy consumption of the electric motor.

### BRIEF DESCRIPTION OF THE DRAWINGS

The foregoing and further features and advantages of the invention will become apparent from the following description of example embodiments with reference to the accompanying drawings, wherein like numerals are used to represent like elements, and wherein:

FIG. 1 is an end view of a rotor of an electric motor according to an example embodiment of the invention as viewed from the axial direction;

FIG. 2 is a sectional view taken along line II-II in FIG. 1;

FIG. 3 is an outline of a rotor manufacturing method;

FIG. 4 is an enlarged view of a section of the upper half of the rotor core in FIG. 2; and

FIG. 5 is a view of a rotor according to related art.

### DETAILED DESCRIPTION OF EMBODIMENTS

Hereinafter, example embodiment of the invention will be described in detail with reference to the accompanying drawings. In the description, the specific shapes, materials, numeric values, and directions and the like are merely examples to facilitate understanding of the invention, and may be changed as appropriate according to the use, objective, and specifications and the like.

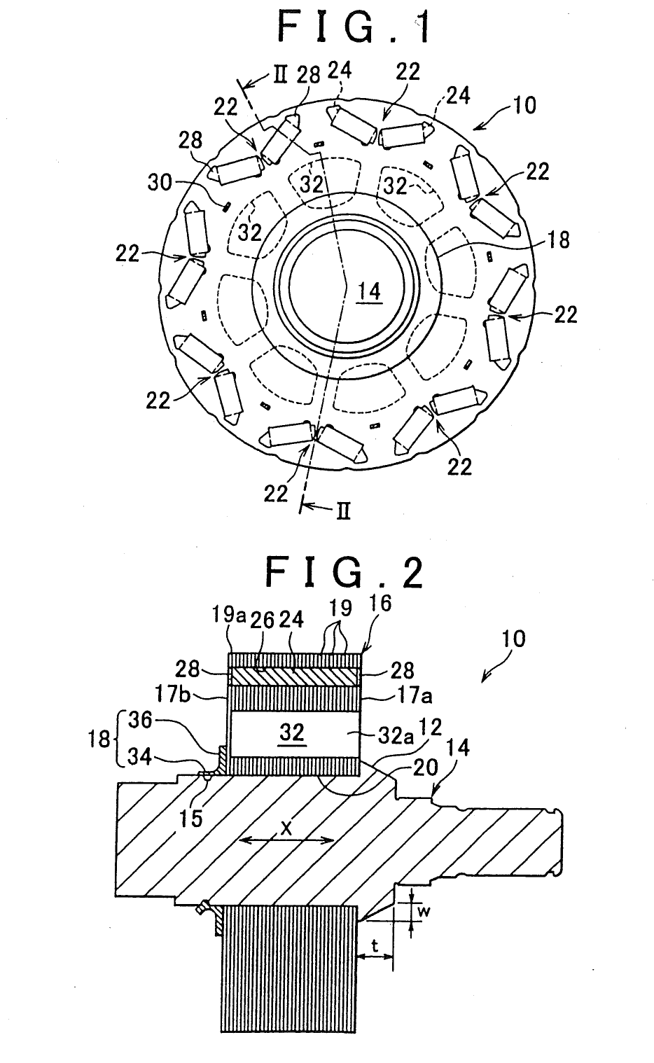

FIG. 1 is a view of an axial end of a rotor 10 according to one example embodiment of the invention. FIG. 2 is a sectional view taken along line II-II in FIG. 1. As shown in the drawings, the rotor 10 includes a rotor shaft 14 that has a flange portion (i.e., a contact portion) 12, a rotor core 16 that is fixed to the outer periphery of the rotor shaft 14, and a crimping member 18 that fixes the rotor core 16 to the rotor shaft 14 in the axial direction (i.e., the direction of arrow X).

The rotor shaft 14 is made of round-bar steel and has a flange portion 12 that protrudes radially outward provided on the outer periphery. The flange portion 12 is integrally formed with the rotor shaft 14. The thickness t of the flange portion 12 in the axial direction, the width w that the flange portion 12 protrudes radially outward, and the shape in which the flange portion 12 protrudes are all designed to be able to withstand the fixing forces of the rotor core 16 in the axial direction.

The rotor shaft 14 is fixed extending completely through a shaft attachment hole 20 formed in the center portion of the rotor core 16. Also, the flange portion 12 of the rotor shaft 14 to which the rotor core 16 is fixed abuts against a peripheral edge portion of the shaft attachment hole 20 on one axial end surface 17a of the rotor core 16.

Incidentally, the flange portion 12 does not necessarily have to be integrally formed with the rotor shaft 14. Alternatively, a flange portion may also be formed as a separate member and fixed by screws or welding or the like to the outer periphery of the rotor shaft. This enables the round-bar steel that is the material of the rotor shaft to be made smaller, thus reducing costs. Also, the rotor shaft is not limited to a solid bar. That is, at least a portion of the rotor shaft may also be hollow.

Also, a key groove, not shown, is formed extending in the axial direction in the rotor shaft 14. A key, also not shown, that is formed protruding radially inward on the inner periphery of the shaft attachment hole 20 of the rotor core 16 is engaged with this key groove. As a result, when the rotor core 16 is fixed on the rotor shaft 14, the rotor core 16 is restricted from rotating in the circumferential direction with respect to the rotor shaft 14.

The rotor core 16 is cylindrical. More precisely, the rotor core 16 has a generally circular cylindrical outer shape, and is formed by stacking multiple magnetic steel sheets 19, each of which has been stamped in an annular or disc shape, in the axial direction and integrally joining them together by crimping or the like. These magnetic steel sheets 19 may be joined together by crimping or the like in the axial direction to form a plurality of separate blocks and then these blocks may be integrally joined together in the axial direction by adhesion or the like, or all of the magnetic steel sheets 19 may be integrated all together by crimping or the like.

A plurality of permanent magnets 24 are embedded in an even arrangement in the circumferential direction in a portion near an outer peripheral portion of the rotor core 16. More specifically, the rotor core 16 has eight magnetic poles 22 uniformly arranged in the circumferential direction. Each magnetic pole 22 is formed by a pair of permanent magnets 24 embedded in a general V-shape. The two permanent magnets 24 that form each magnetic pole 22 have a flat rectangular end face shape and sectional shape, and are arranged such that the end portions that face each other at a close distance in the circumferential direction are positioned slightly offset toward the center of the rotor core 16, and from there, the pair of permanent magnets 24 spread out in a general V-shape toward the outer peripheral surface of the rotor core 16.

The permanent magnets 24 are fixed inserted into permanent magnet insertion holes 26 formed extending through the rotor core 16 in the axial direction. The permanent magnet insertion holes 26 are open on both end surfaces 17a and 17b of the rotor core 16 in the axial direction, such that the permanent magnets 24 can be inserted into the permanent magnet insertion holes 26 from either open portion.

The permanent magnets 24 arranged in the permanent magnet insertion holes 26 are fixed in the permanent magnet insertion holes 26 by resin material 28 that is filled in a narrow gap between the four side surfaces of the permanent magnets 24 that have a flat rectangular end face shape, and the inner wall surface of the permanent magnet insertion holes 26 formed in the rotor core 16. Also, the resin material 28 closes the open portion that is open on both end surfaces of the rotor core 16 while covering both axial end surfaces of the permanent magnets 24. As a result, the permanent magnets 24 are firmly fixed in the permanent magnet insertion holes 26, so they will not jounce around or fly out of the rotor core 16 when the rotor rotates.

In the rotor core 16, crimping concave portions (or crimping convex portions) 30 formed when the magnetic steel sheets 19 are joined are formed in positions corresponding to in between the magnetic poles 22. Also, a plurality (eight in this example embodiment) of weight-reducing holes 32 are formed in a uniform arrangement around the shaft attachment hole 20 to the radial inside of the crimping concave portions 30 in positions corresponding to in between the magnetic poles 22.

The weight-reducing holes 32 reduce the weight of the rotor 10, thereby enabling it to rotate more easily, and are formed extending almost completely through the rotor core 16 in the axial direction. However, although the weight-reducing holes 32 are open on one axial end surface 17a of the rotor core 16, they are closed by, for example, one magnetic steel sheet 19a that is farthest to the outside in the axial direction on the other axial end surface 17b of the rotor core 16. This is done to prevent the resin material 28 from flowing into the weight-reducing holes 32 when the molding resin material 28 is filled by injection molding or the like into the permanent magnet insertion holes 26 from the side on which the magnetic steel sheet 19a is arranged.

Open portions 32a of the weight-reducing holes 32 that are open on the one axial end surface of the rotor core 16 preferably form means for generating noise by rotating and cutting the air inside the electric motor when the electric motor that incorporates the rotor 10 is rotatably driven at a relatively low speed. The noise generated in this way makes it possible to alert pedestrians when a vehicle powered partially or entirely by electricity, such as a hybrid vehicle or an electric vehicle that runs at low speeds using power generated by an electric motor, (hereinafter simply referred to as an “electric vehicle”) approaches. The number, size, and shape and the like of the open portions 32a of the weight-reducing holes 32 may be designed to produce noise with a tone and sound pressure suitable for alerting a pedestrian that an electric vehicle is approaching. In this case, the noise may also be increased by, for example, leaving the burrs that form on the peripheral edge portion of the opening of the open portion 32a when stamping the magnetic steel sheets 19, for example.

The crimping member 18 includes a cylindrical crimping portion 34 and a pressing portion 36 that protrudes in a flange shape radially outward from one end portion of the crimping portion 34. The crimping member 18 is a member that is made of metal, for example, and is strong enough to be able to support a predetermined fixing force in the axial direction required for the rotor core 16.

Also, the crimping member 18 is fixed onto the rotor shaft 54 by the crimping portion 34 being pressed and crimped into a crimping groove 15 formed on the outer periphery of the rotor shaft 14, while the pressing portion 36 pushes a peripheral portion of the shaft attachment hole 20 at the other axial end surface 17b of the rotor core 16 with a predetermined pressure contact force toward the flange portion 12. Accordingly, the rotor core 16 is able to be fixed directly, not via end plates, between the flange portion 12 of the rotor shaft 14 and the crimping member 18 that is crimp-fixed on the rotor shaft 14, in the axial direction of the rotor shaft 14.

According to the rotor 10 of this example embodiment, the end plates are able to be eliminated from the rotor 10 by directly fixing the rotor core 16 between the flange portion 12 of the rotor shaft 14 and the crimping member 18. As a result, the desired fixing force in the axial direction at low temperatures can be obtained even if the initial pressure contact force against the rotor core end surface 17b when crimp-fixing the crimping member 18 is reduced, so the crimping equipment can be small and inexpensive.

Moreover, the initial pressure contact force can be reduced as described above, so the crimping member 18 can also be weaker and less expensive by making it thinner or changing the material or the like.

Furthermore, eliminating the end plates reduces the number of component parts, thus making it possible to reduce the cost of the rotor 10, as well as makes the electric motor lighter which helps to reduce the energy consumption of the electric motor.

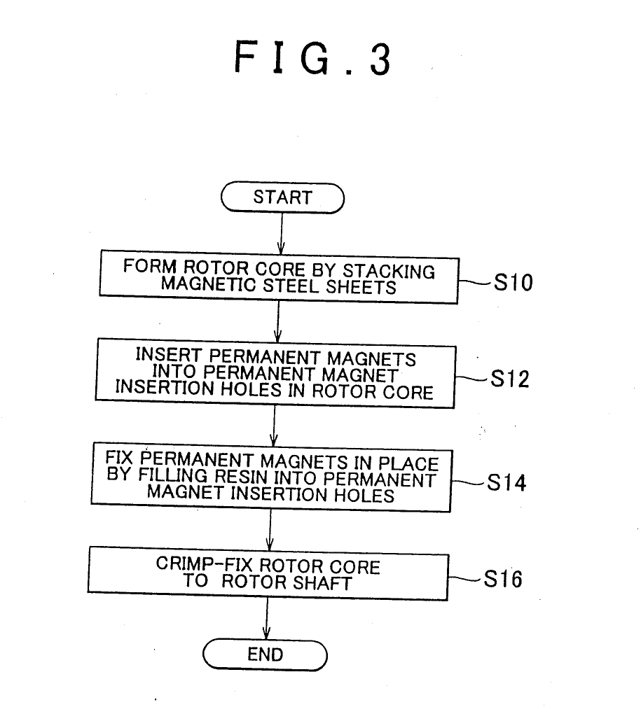

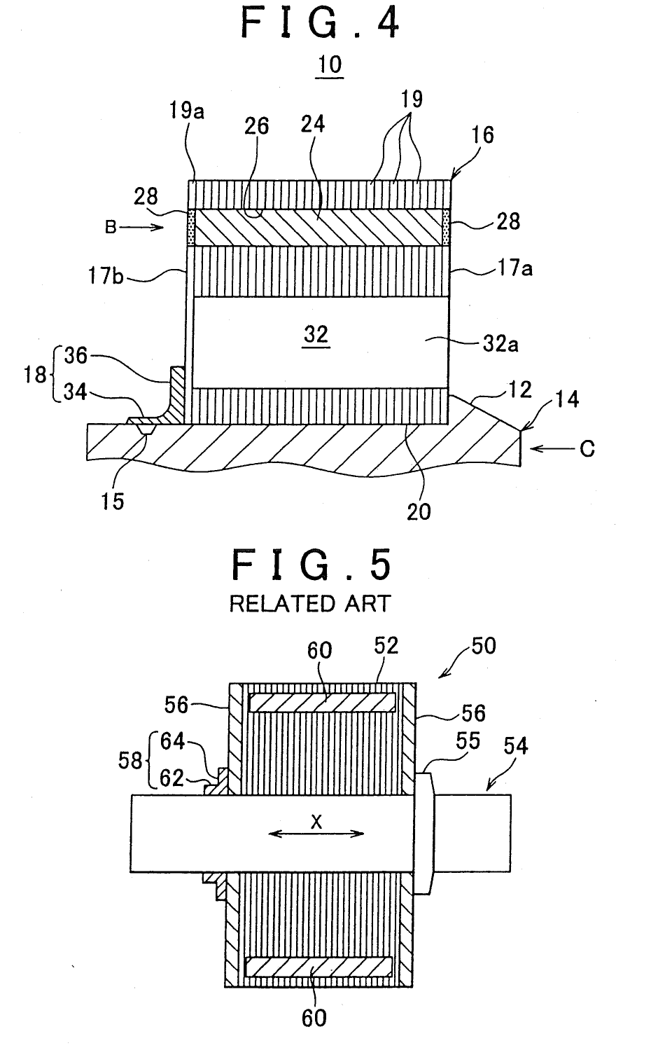

Next, a manufacturing method of the rotor 10 described above will be briefly described with reference to FIGS. 3 and 4. FIG. 3 is an outline of the manufacturing method of the rotor 10, and FIG. 4 is an enlarged view of a section of the upper half of the rotor core 16 in FIG. 2.

As shown in FIG. 3, first in step S10, the rotor core 16 is formed by stacking magnetic steel sheets 19 that have been formed by stamping, and joining these together by crimping or the like.

Next, in step S12, the permanent magnets 24 are inserted in the direction of arrow B in the axial direction into the permanent magnet insertion holes 26 of the rotor core 16 from the other axial end surface 17b of the rotor core 16.

Continuing on, in step S14, the permanent magnets 24 are fixed inside the permanent magnet insertion holes 26 by filling the resin material 28 inside the permanent magnet insertion holes 26 as described above, while the permanent magnets 24 are arranged in the position shown in FIG. 4, i.e., with both axial end surfaces of the permanent magnets 24 that are slightly shorter than the length of the rotor core 16 in positions set slightly back from both axial end surfaces 17a and 17b of the rotor core 16. At this time, the open portions of both axial ends of the permanent magnet insertion holes 26 are also closed by the resin material 28.

Then in step S16, the rotor shaft 14 is inserted in the direction of arrow C through the shaft attachment hole 20 in the rotor core 16 to which the permanent magnets 24 are fixed as described above, and the crimping member 18 that is fitted onto the rotor shaft 14 from the opposite direction is crimp-fixed to the crimping groove 15 of the rotor shaft 14 using crimping equipment. As a result, the rotor core 16 in which the permanent magnets 24 are embedded is fixed to the rotor shaft 14, thus completing the internal magnet-type rotor 10.

Incidentally, in the example embodiment described above, the open portions, on the other axial end surface 17b side, of the weight-reducing holes 32 in the rotor core 16 are closed by the magnetic steel sheet 19a. Alternatively, however, the weight-reducing holes 32 may also be open on both sides in the axial direction by using a magnetic steel sheet like the other magnetic steel sheets 19 instead of this magnetic steel sheet 19a. This structure would enable the noise produced as the rotor 10 rotates when the electric motor is driven as described above to be even louder, and would thus be even more effective as notifying means for notifying a pedestrian that an electric vehicle is approaching.

Although the invention has been described with reference to the example embodiments thereof, it is to be understood that the invention is not limited to the particulars of the disclosed embodiments. To the contrary, the invention is intended to cover various modifications and equivalent arrangements. In addition, while the various elements of the example embodiments of the invention are shown in various combinations and configurations, other combinations and configurations, including more, less or only a single element, are also within the scope of the invention.

1. A rotor of an electric motor, comprising:
a rotor core that is formed by stacked magnetic steel sheets and includes a permanent magnet;
a rotor shaft to which the rotor core is fixed;
a contact portion that is provided on an outer periphery of the rotor shaft and that abuts against one axial end surface of the rotor core; and
a crimping member that is crimp-fixed on the rotor shaft, wherein
the rotor core is directly fixed, in an axial direction of the rotor shaft, between the contact portion and the crimping member.

2. The rotor according to claim 1, wherein a permanent magnet insertion hole for inserting the permanent magnet is formed extending in the axial direction in the rotor core, and a weight-reducing hole for reducing a weight of the rotor is formed extending in the axial direction, in a position radially inward of the permanent magnet insertion hole, in the rotor core; and the weight-reducing hole is open at least at one axial end surface of the rotor core.

3. The rotor according to claim 2, wherein the permanent magnet inserted into the permanent magnet insertion hole is fixed in place by resin material filled between an inner wall of the permanent magnet insertion hole and a side surface of the permanent magnet.

4. The rotor according to claim 3, wherein an open portion, in the axial end surface of the rotor, of the permanent magnet insertion hole is closed off by the resin material.

5. A manufacturing method of a rotor of an electric motor in which a rotor core that is formed by stacked magnetic steel sheets and provided with a permanent magnet is fixed to a rotor shaft, comprising:
forming the rotor core by stacking the magnetic steel sheets;
inserting the permanent magnet into a permanent magnet insertion hole that is provided in the rotor core;
fixing the permanent magnet to the rotor core by filling a resin material into the permanent magnet insertion hole;
inserting the rotor shaft into a shaft attachment hole in a center portion of the rotor core and directly abutting one axial end surface of the rotor core against a contact portion provided on an outer periphery of the rotor shaft; and
fixing the motor core directly between the contact portion and a crimping member that is crimp-fixed on the rotor shaft, in an axial direction of the rotor shaft.
